(19) United States
(12) Patent Application Publication
(10) Pub. No.: US 2025/0342189 A1
(43) Pub. Date: Nov. 6, 2025

(54) SHORT MESSAGE E-DISCOVERY SYSTEM

(71) Applicant: Arc Holdings LLC, Denver, CO (US)

(72) Inventors: Andreas MUELLER, Glendale, AZ (US); Michael SCHUBERT, Scottsdale, AZ (US); Tom ZALESKI, Gilbert, AZ (US); Noah O'Brien, Phoenix, AZ (US); Venkataraman THYUAGARAJAN, Karnataka (IN); Tyler PATTERSON, Peoria, AZ (US); Cody LUERA, Gilbert, AZ (US)

(21) Appl. No.: 19/197,783

(22) Filed: May 2, 2025

Related U.S. Application Data
(60) Provisional application No. 63/642,430, filed on May 3, 2024.

(51) Int. Cl. G06F 16/334; G06F 3/0354; G06F 3/04842; G06F 3/0488; H04L 51/216

(52) U.S. Cl. CPC G06F 16/334; G06F 3/03545; G06F 3/04842; G06F 3/0488; H04L 51/216

(57) ABSTRACT

The discovery process in criminal and civil litigation frequently produces a large body of digital data. The digital data may come from computers, smartphones and other electronic devices (sources) of one or more people related to the litigation. Each source may have digital data from one or more applications and/or programs (platforms). The digital data may include, as non-limiting examples, contact lists, messages (possibly with emojis), photos, videos, audio and/or location data as non-limiting examples. The digital data from the various sources and platforms may be normalized and combined into a corpus of digital data. Digital forensic tools, possibly even an artificial intelligence (AI) may then be used to analyze the corpus of digital data.

### CROSS-REFERENCE TO RELATED APPLICATIONS

This U.S. Non-Provisional patent application claims the benefit of U.S. Provisional Application 63/642,430, filed May 3, 2024, and titled E-DISCOVERY SYSTEM, which is fully incorporated herein by reference as if fully set forth herein.

### BACKGROUND OF THE INVENTION

The present invention generally relates to the field of collecting, storing, searching and displaying data.

Civil and criminal litigation proceedings often involve one or more parties litigating against one or more other parties in a court of law. A lawsuit may involve resolution of disputes involving issues of private law between individuals, business entities or non-profit organizations. A lawsuit may also involve issues of public law where the state is treated as if it were a private party in a civil case, either as a plaintiff with a civil cause of action to enforce certain laws, or as a defendant in actions contesting the legality of the state's laws or seeking monetary damages for injuries caused by agents of the state. Litigation may also refer to the conducting of criminal actions, where the state enforces a criminal code against one or more parties in a court of law.

The rules of civil and criminal litigation include a discovery process, where the parties are allowed to request and obtain varies types of evidence from the opposing parties or other people with relevant evidence. With the advent of computers, smartphones, and other electronic devices much of the evidence obtained is in the form of digital data. The amount of digital data on the parties' computers, smartphones and electronic devices may be vast, with most of the digital data often being irrelevant. What is needed is a method of finding the relevant data out of all of the data collected in the litigation.

Use of mobile devices, short communications and social media has permeated every part of business communication these days. The use of chat and short text messages has changed the eDiscovery space considerably and poses highly specific challenges in the area. Finding the most relevant messages can mean the difference between winning and losing the litigation.

### SUMMARY OF THE INVENTION

Accordingly, the invention relates to the field of collecting, storing, searching and displaying data.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the figures.

A first embodiment may be a method for determining relevant messages during an e-discovery process. A plurality of messages may be imported from each of a plurality of communication applications from each of a plurality of electronic devices from each of a plurality of entities. The electronic devices may be computers and cell phones. The plurality of messages may be stored in chronological order in a file share. A search query may be received from a user, wherein the search query may comprise one or more search terms, boolean logic and a proximity indicator. A hit plurality of messages may be determined in the plurality of messages in the file share that satisfy the search query. A context plurality of messages may be determined in the plurality of messages that are immediately before or immediately after the hit plurality of messages. The hit plurality of messages may be displayed to the user that satisfy the search query in a functional display window. It may be detected that the user selected a view more command associated with a hit message in the hit plurality of messages. The view more command, as an example, may be for a message before the hit message. In this case a context message may be displayed from the context plurality of messages immediately before the hit message in the functional display window.

A second embodiment may be a method for searching for one or more messages out of a corpus of messages. A first plurality of messages may be received from a first application on a first device. A second plurality of messages may be received from a second application on a second device. The first plurality of messages and the second plurality of messages may be normalized and combined to create the corpus of messages. The corpus of messages may be scraped for emoji used in the corpus of messages. The corpus of messages may be scraped for keywords used in the corpus of messages. An emoji cloud built from the used emoji may be displayed. A keyword cloud built from the used keywords may be displayed. A selected one or more emojis from the emoji cloud may be detected. A selected one or more keywords from the keyword cloud may be detected. The one or more messages out of the corpus of messages that includes the selected one or more emojis from the emoji cloud and the selected one or more keywords from the keyword cloud may be displayed.

A third embodiment may be a method for displaying a single conversation thread based on messages from a plurality of platforms. A first plurality of messages may be received from a first application on a first device. A second plurality of messages may be received from a second application on the first device. The first plurality of messages and the second plurality of messages may be normalized and combined. The first plurality of messages from the first application and the second plurality of messages from the second application may be placed in chronological order to create a single conversation thread. The single conversation thread may be displayed on a user interface.

This Summary section is neither intended to be, nor should be, construed as being representative of the full extent and scope of the present disclosure. Additional benefits, features and embodiments of the present disclosure are set forth in the attached figures and in the description hereinbelow, and as described by the claims. Accordingly, it should be understood that this Summary section may not contain all of the aspects and embodiments claimed herein.

Additionally, the disclosure herein is not meant to be limiting or restrictive in any manner. Moreover, the present disclosure is intended to provide an understanding to those of ordinary skill in the art of one or more representative embodiments supporting the claims. Thus, it is important that the claims be regarded as having a scope including constructions of various features of the present disclosure insofar as they do not depart from the scope of the methods and apparatuses consistent with the present disclosure (including the originally filed claims). Moreover, the present disclosure is intended to encompass and include obvious improvements and modifications of the present disclosure.

### BRIEF DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates a chat review, possibly from a plurality of different smartphones and computers and possibly from data from a plurality of different platforms;

FIG. 2 illustrates a user interface that may be used to track financial transactions;

FIG. 3 illustrates a user interface for a journey/location analyzer;

FIGS. 4 and 5 illustrate a user interface showing a heat map;

FIG. 6 illustrates possible components of an E-discovery system according to a possible embodiment of the invention.

FIG. 7 illustrates a high-level flow diagram of an E-discovery method according to a possible embodiment of the invention.

FIG. 8 illustrates a process for preparing conversations flow in an E-discovery method according to a possible embodiment of the invention.

FIG. 9 illustrates an example of raw data for a conversation blog that contains information about conversations and the messages of the conversations according to a possible embodiment of the invention.

FIG. 10 illustrates an example messages section which contains the text of each message along with the metadata for each message and each message's order number in the conversation.

FIG. 11 illustrates an example of indexed data after the data from the messages section has been indexed according to a possible embodiment of the invention.

FIG. 12 illustrates an example of an offsets blob that contains message boundaries in terms of offsets and tokenized word boundaries according to a possible embodiment of the invention.

FIG. 13 illustrates an example of an index flow that generates an index file share according to a possible embodiment of the invention.

FIG. 14 illustrates an example of a search flow that generates results, i.e., search results according to a possible embodiment of the invention.

FIG. 15 illustrates an example of a message extraction process according to a possible embodiment of the invention.

FIG. 16 illustrates an example of a large conversation and a method for enhancing performance according to a possible embodiment of the invention.

FIG. 17 illustrates a user interface with a view of messages with columns for “Type,” “Source Application,” “Data Source,” “Participants,” “Date First,” “Date Last,” and “Description” with some collapsed messages according to an embodiment of the invention.

FIG. 18 illustrates a user interface similar to FIG. 6, but with an updated view of search results with some of the collapsed views now expanded according to an embodiment of the invention.

FIG. 19 illustrates a portion of a user interface that allows a user to select a time period for a desired hit window.

### DETAILED DESCRIPTION OF THE INVENTION

The following detailed description describes an apparatus that enables a user to search across multiple database records with individual database records using advanced boolean logic. The multiple database records function as one record while maintaining the ability to reference and interact with individual records in the search results. The description is presented to enable any person skilled in the art to make and use the disclosed subject matter in the context of one or more particular implementations. Various modifications, alterations, and permutations of the disclosed implementations can be made and will be readily apparent to those skilled in the art, and the general principles defined may be applied to other implementations and applications, without departing from scope of the disclosure. The present disclosure is not intended to be limited to the described or illustrated implementations, but to be accorded the widest scope consistent with the described principles and features.

For the purposes of promoting an understanding of the principles of the present disclosure, reference will now be made to the exemplary embodiments illustrated in the drawing(s), and specific language will be used to describe the same.

Appearances of the phrases an “embodiment,” an “example,” or similar language in this specification may, but do not necessarily, refer to the same embodiment, to different embodiments, or to one or more of the figures. The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps unless explicitly stated otherwise.

Reference will now be made in detail to an embodiment of the present invention, an examples of which is illustrated in the accompanying drawings.

Civil and criminal litigation are proceedings by one or more parties against one or more other parties in a court of law. A lawsuit may involve resolution of disputes involving issues of private law between individuals, business entities or non-profit organizations. A lawsuit may also involve issues of public law where the state is treated as if it were a private party in a civil case, either as a plaintiff with a civil cause of action to enforce certain laws, or as a defendant in actions contesting the legality of the state's laws or seeking monetary damages for injuries caused by agents of the state. Litigation may also refer to the conducting of criminal actions, where the state enforces a criminal code against one or more parties in a court of law.

The rules of civil and criminal litigation include a discovery process, where the parties are allowed to request and obtain varies types of evidence from the opposing parties or other people with relevant information. With the advent of computers, smartphones, and electronic devices, i.e., sources, much of the evidence obtained is in the form of digital data.

The amount of digital data on the parties' computers, smartphones and other electronic devices may be vast, but with most of the digital data being irrelevant. However, the small relevant portions of the digital data may be crucial in properly resolving the lawsuit. It is thus critical to have a means of analyzing data from multiple parties, where each party may have multiple computers, smartphones and electronic devices and each computer, smartphone and electronic device may be operating multiple applications and programs, and where each application and program may store different types of data or even the same types of data in different formats from other applications and programs.

Various embodiments of the present invention allow a user to download all of the desired data from all of the different entities collected computers, smartphones, and electronic devices from various applications and programs and combine the data in an intelligent manner, filter the data and display the data on a user interface such that the user is able to find the relevant data for the lawsuit.

Documents are generally required for the review process in ediscovery. As a result, ediscovery often consists of processing phones and short message data to a time-based transcript in a document format. These transcripts are frozen in time artifacts such as PDFs or emails that require all elements to be there and are segmented into time-based sets of conversation.

However, in preferred embodiments, a dynamic data system may be used that manages the conversation at the message level. This embodiments architecture gives the system flexibility and feature sets not available in a document-based paradigm.

A computer network is a collection of links and nodes (e.g., multiple computers and/or other devices connected together) arranged so that information may be passed from one part of the computer network to another over multiple links and through various nodes. Examples of computer networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between clients and website resources stored on hosting servers. Hundreds of millions of people around the world have access to computers connected to the Internet via Internet Service Providers (ISPs). Content providers place website resources, such as, as non-limiting examples, multimedia information (e.g., text, graphics, audio, video, animation, and other forms of data) at specific locations on the Internet which may be operated from hosting servers. The combination of all the websites, website resources and their corresponding web pages on the Internet are generally known as the World Wide Web (WWW) or simply the Web.

For clients and businesses alike, the Internet continues to be increasingly valuable. Clients may use, as non-limiting examples, a cell phone, PDA, tablet, laptop computer, or desktop computer to access websites or servers, such as hosting servers, via a computer network, such as the Internet.

Websites may consist of a single webpage, but typically consist of multiple interconnected and related webpages. Websites, unless very large and complex or have unusual traffic demands, typically reside on a single hosting server and are prepared and maintained by a single individual or entity (although websites residing on multiple hosting servers are certainly also used). Menus, links, tabs, etc. may be used by clients to move between different web pages within the website or to move to a different website, possibly on the same or a different hosting server.

Websites may be created using HyperText Markup Language (HTML) to generate a standard set of tags that define how the webpages for the website are to be displayed. Clients on the Internet may access content providers' websites using software known as an Internet browser, such as Microsoft Edge, Google Chrome, Safari or Firefox. After the browser has located the desired webpage, the browser requests and receives information from the webpage, typically in the form of an HTML document, and then displays the webpage content for the client on a user interface. A user may use the interface to see displayed information and to select items and/or enter various information as desired. The client may then view other webpages at the same website or move to an entirely different website using the browser.

Some website operators, typically those that are larger and more sophisticated, may provide their own hardware, software, and connections to the Internet. The server or hosting server comprise hardware servers and may be, as non-limiting examples, one or more Dell PowerEdge(s) rack server(s), HP Blade Servers, IBM Rack or Tower servers, although other types of servers and combinations of one or more servers may be used. Various software packages and applications may run on the servers as desired.

Embodiments of the present invention may be run on any desired conceptual search engine. As a non-limiting example, the conceptual search engine may be provided by the Microsoft Azure ecosystem. Microsoft Azure ecosystem is a cloud-based business applications platform that combines components of Customer Relationship Management (CRM), and Enterprise Resource Planning (ERP), along with productivity applications and Artificial Intelligence or AI. These pillars reside on top of a Common Data Service platform. Microsoft Azure is a public cloud platform. Azure offers a large collection of services, which includes platform as a service (PaaS), infrastructure as a service (IaaS), and managed database service capabilities.

Entities for the present invention are defined to be the most important people or organizations in a litigation. As an example, if company A is in litigation with company B, there are people in company A and company B that are likely to be considered entities, i.e., the most important people to the litigation. Entities are typically the people performing the actions most relevant to the litigation. Thus, entities are often the creators and custodians of the most relevant records and evidence (data) for the lawsuit. The entities may be auto-created if information is collected from them.

The data from the entities may come from various sources, hereby defined to be the entities' personal and work smartphones, computers and other electronic devices. Data from the sources may be automatically downloaded from the electronic devices and stored in a database. The data may include one or more phone contact lists and/or one or more application contact lists. The applications (often referred to as apps) may be social media applications and/or messaging applications. As non-limiting examples, data may be collected from the applications Signal, Telegram, Messenger, Viber, Skype, Line, WhatsApp, Facebook and/or Outlook or any other application that sends or receives messages, pictures, videos, audio or financial data or creates and collects data regarding the entity, such as location/time data. The phone contact lists and application contact lists may be scraped and collapsed, i.e., deduplicated, into a single contact list.

The data associated with each entity may be normalized. The normalization process preferably includes collecting the same types of data and storing the data in the same format, if it exists, for each entity. As non-limiting examples, the data may include, but is not limited to, the contact lists of an entity, photographs and videos taken by or showing the entity, messages sent to or received by the entity, audio files or voice messages taken by or of the entity, and location/time data for the entity. The data is preferably normalized by using the same formatting rules for storing the data for each entity regardless of which application or program created the data.

Additional entities may be found based on the data from the original entities. The process of collecting data from the additional entities to determine even more possible entities may be repeated any number of times as desired.

The data collection process as described thus far is likely to produce duplicate entities for the same entity. This is likely as people do not use consistent names for themselves or others when making contact lists or using applications. As examples, people might use or omit a middle name, use pet names, use nicknames or use descriptive names, such as “brother,” while other entities may use their actual name. Embodiments of the invention may automatically deduplicate entities by determining which entities are likely to be the same entity based on commonalities between the duplicated entities that indicate the duplicates are actually the same person. In some embodiments, a user may also manually de-duplicate, i.e., merge the data for two or more entities into one entity. The de-duplicate process associates the data from the duplicated entities to a single entity.

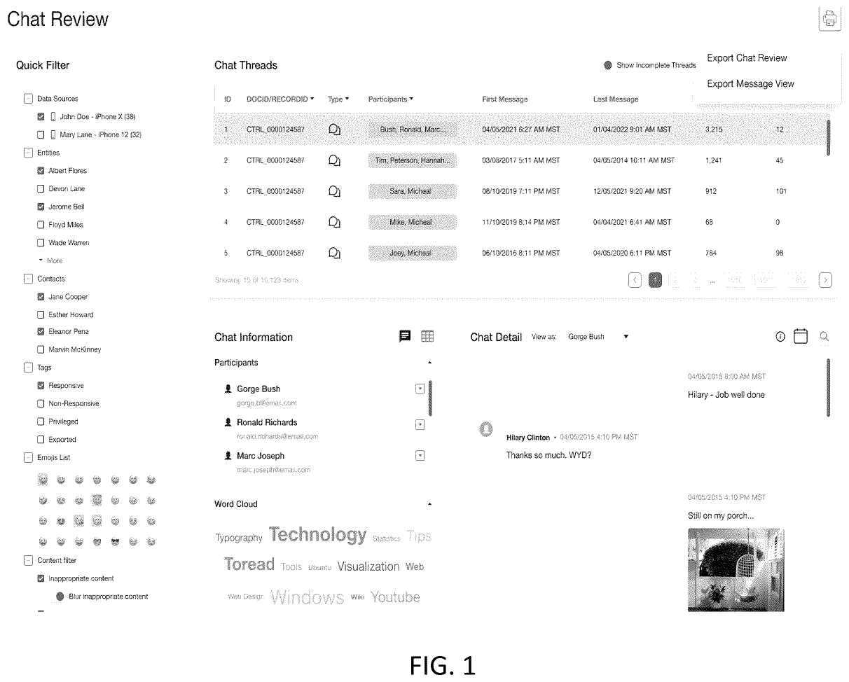

FIG. 1 illustrates a user interface that lists a plurality of different chat threads from the data and displays a portion of a selected chat thread. The chat threads may be scrolled though to reveal additional chat threads when there in insufficient space on the user interface to display all of the chat threads. The portion of the selected chat thread may also be scrolled through to reveal additional messages that are part of the chat thread. By default, each originating application is its own thread so a conversation between two participants (a participant could be a contact or an entity) would be at least two threads. If the entities used iMessage, email, WhatsApp, Discord, Telegram, etc., each of these source apps would be their own thread in some of the embodiments of the invention. A radio button may be used to combine all of these different threads into a single, chronologically sorted order, while indicating on a message level, what the source application for the message was (i.e., Twitter, FB Messenger, iMessage, etc.).

All of the emojis may be scraped from, as non-limiting examples, chat messages, instant messages and emails. Similar looking emojis or emojis with similar meaning may have different encoding on the backend of different applications and programs. In some embodiments, similar looking or similar meaning emojis from different programs and applications may be collapsed together when analyzed.

In various embodiments, an Android device may use Android Native Messenger which stores messages as one-way messages, i.e., no thread or chat identification for the messages. In some embodiments, a custom communication thread may be created from the individually stored messages. A combined contact list may also be created. All of the participants in a conversation may be alphabetized. A custom string may be created based on the participants in the conversation. Each messages' participants may be ordered in alpha/numeric order and then used as an identifier (or “fingerprint”). When the identifier or fingerprint matches, that indicates the conversation where the message belongs. An entire conversation may be created by matching the custom string to all of the messages to select messages that are part of the conversation.

In accordance with embodiments of the present system, data reflecting communications between various entities via multiple separate applications and threads may be processed such that a single conversation thread may be created, even though the conversation took place over a plurality of different platforms (a cross-platform conversation). As a non-limiting example, entities or some other person(s) may start a conversation on Instant Message in the morning, then in the afternoon move the conversation to Facebook, then in the evening start using an application such as Viber and then in the morning start the conversation again on Instant Message (or any other combination). The messages from the different applications and/or electronic devices may be displayed on a user interface listing the messages in chronological order. In preferred embodiments, icons or other means may be used to indicate the source and/or application for each message in the chat thread.

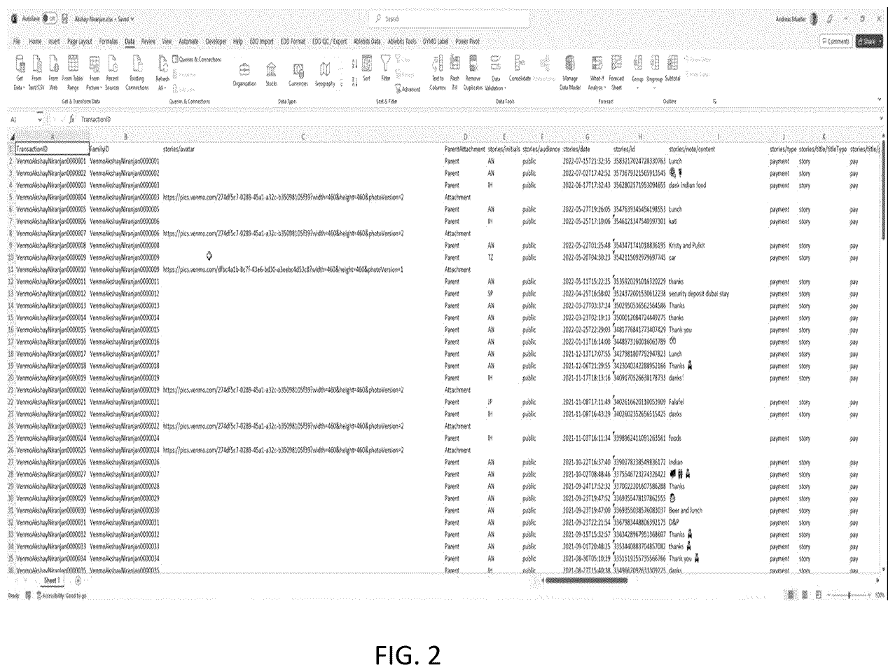

Referring to FIG. 2, in other embodiments, one or more financial transactions (such as from Venmo or the web) may be included in the conversation thread, i.e., who sent and who received the financial transaction and possibly the amount of the transaction. In preferred embodiments, the financial transaction is displayed in the chat thread in chronological order with the other chat messages. In some embodiments, AI classifiers may be used to find the financial transactions to be included in the conversation thread.

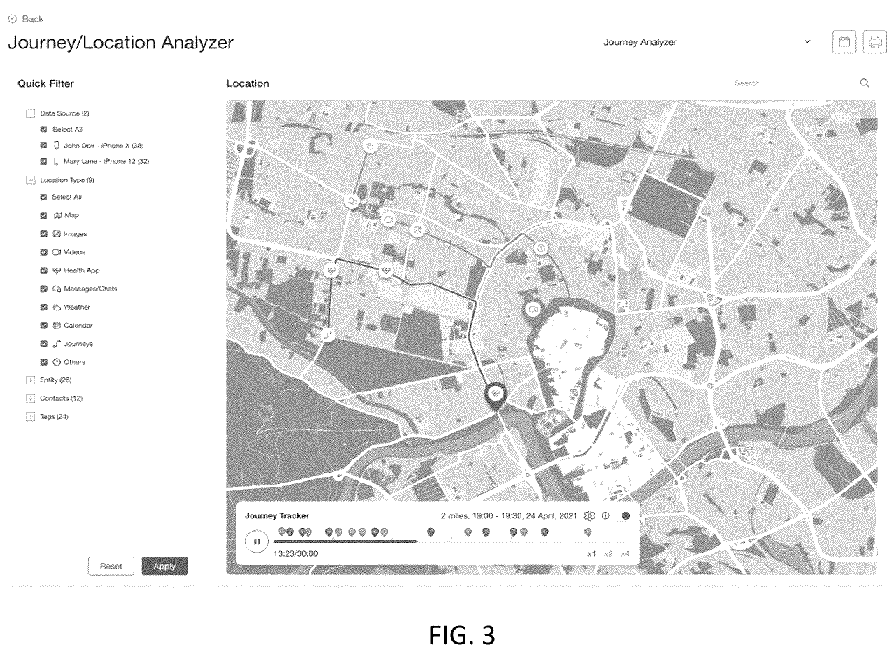

Referring to FIG. 3, a Journey/Location Analyzer is illustrated. A map may be used to display a tracking line of locations for each selected entity over a selected period of time. This may be used to show if entities were ever physically at the same place at the same time. In some embodiments, an icon may show which application collected the location data, as non-limiting examples, a health app, video taken, photo taken, message/chats, weather and/or calendar journeys may have been used to collect the location data.

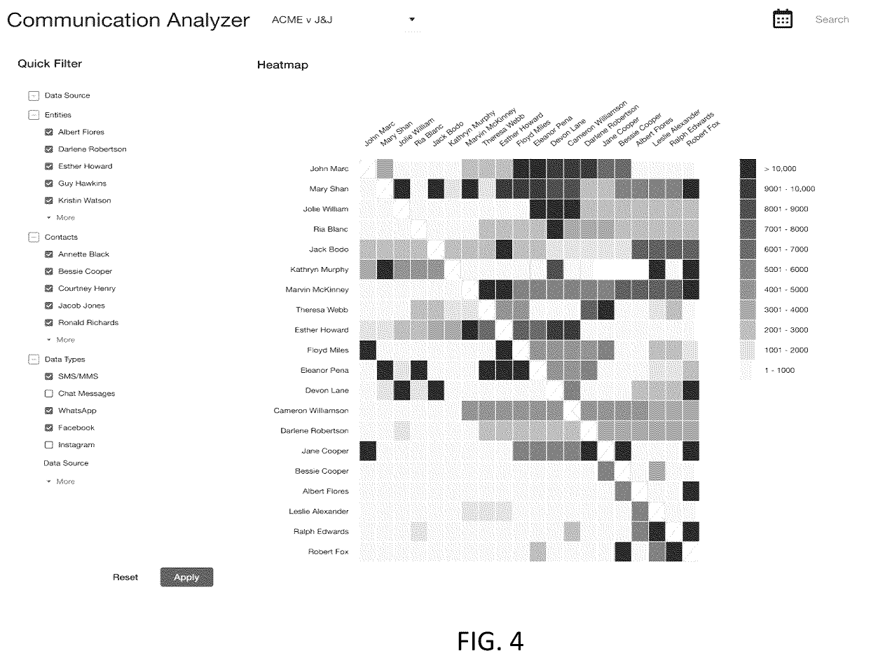

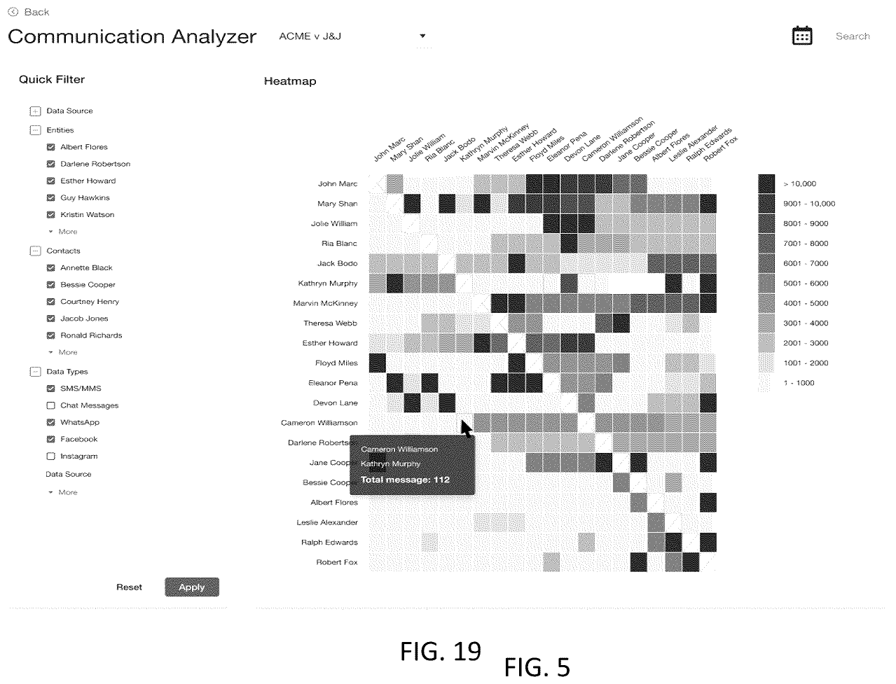

Referring to FIGS. 4 and 5, a user interface may display a Heat Map showing who talked to whom and how many times. In some embodiments, the displayed Heat Map may show who talked to whom where a preselected word was said or typed in a message. In other embodiments, the displayed Heat Map may show who talked to whom where a preselected word was said or typed in a message during a preselected time period, such as on a selected date.

In some embodiments, a pop-up may appear requesting the minimum number of messages per conversation that a conversation thread must have before being included in the summarization and whether cross-platform or per original thread (conversation per platform) should be used in the summarization.

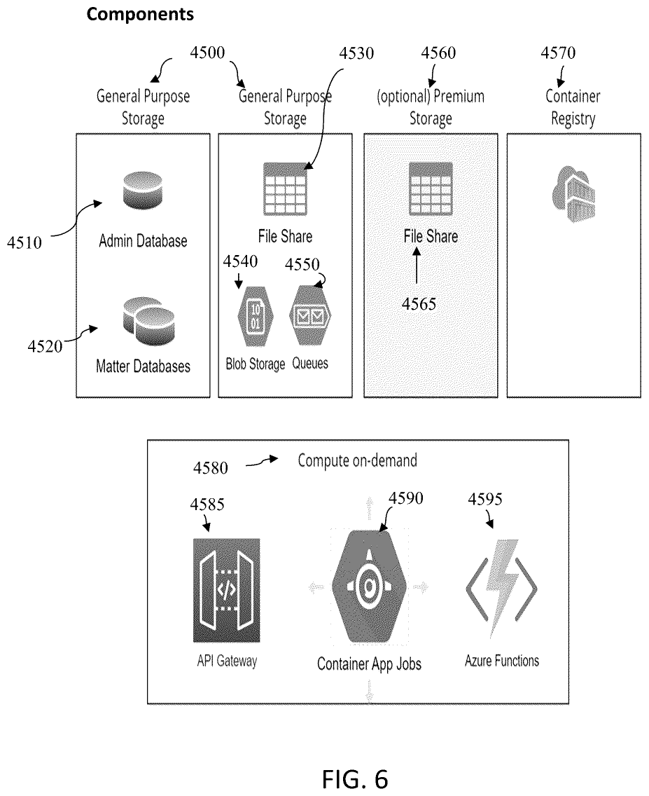

Referring to FIG. 6, possible components for an ediscovery system are illustrated. The possible components for an ediscovery system may include one or more of a general purpose storage 4500, premium storage 4560, container registry 4570 and compute on-demand 4580 components.

The general purpose storage 4500 of the ediscovery system may include an admin database 4510. The admin database 4510 may store control information for the entire ecosystem of the ediscovery system. As non-limiting examples, the admin database 4510 may store lists of matters, databases, data sources and queues 4550.

The general purpose storage 4500 of the ediscovery system may include one or more matter databases 4520. In preferred embodiments, there is only one matter database 4520 per matter. The matter databases 4520 may contain message level data which may be grouped by channels and have groups for various sources like Slack, Teams, WhatsApp, Instagram etc. Keeping data stored at the message level allows for recording user data at the individual message level as well as linking messages to the index and offset information stored in the index files.

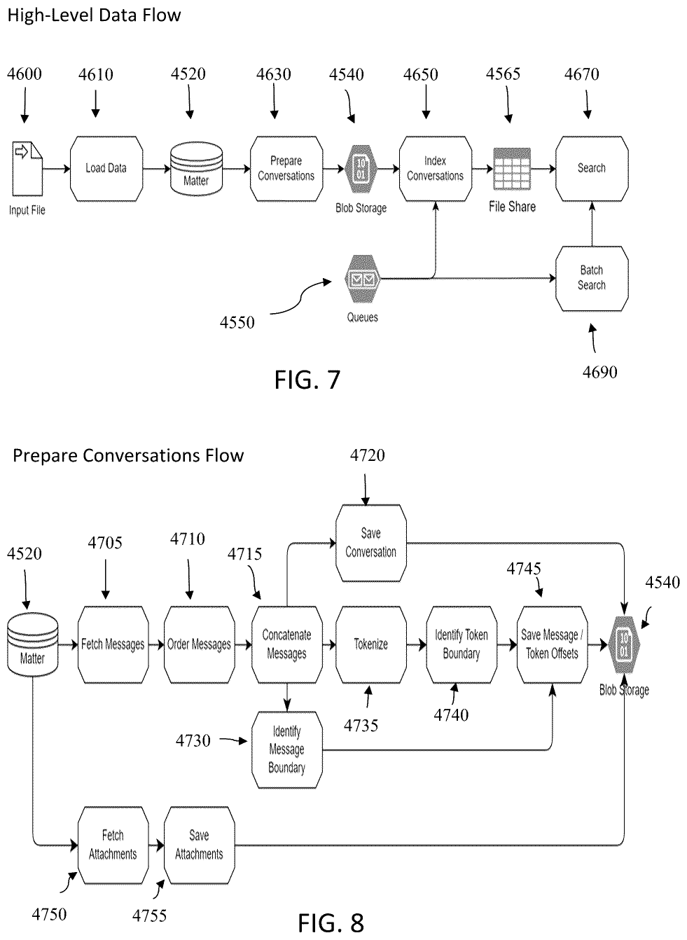

The general purpose storage 4500 of the ediscovery system may include a blob storage 4540. All prepared conversations, messages, emails, and attachments are preferably first processed and stored in the blob storage 4540. The method will be further discussed with reference to the high level dataflow illustrated in FIG. 7.

The premium storage 4560 may include a file share 4565. The file share 4565 may have any number of desired purposes. In a non-limiting example, the file share 4565 may have two purposes. The first purpose may be for the file share 4565 to be used to hold information for the compute of function app. The second purpose for the file share 4565 may be to store Lucene indexes for searches. Lucene indexes may store a plurality of documents that form a document body. Each document in the document body may have one or more fields of data. The document body may be tokenized and indexed while other fields in the documents may be stored as is. The Lucene indexes may further be used to store text pertaining to conversations, emails, attachments, documents, etc. In some embodiments, the Lucene indexes may be customized regarding how these messages and conversations are organized so that information may be retrieved across one or more messages in a single query. Multiple Lucene indexes may also be used to coordinate tags (user work product) and analytics data in the Lucene index. The query process may be customized to fetch information for complex queries. An index file share may be stored in the general purpose storage 4500 or optionally in the Azure Premium File share to enhance performance.

The components of the ediscovery system may also include a container registry 4570. The container registry 4570 may hold container images for running container app jobs 4590.

The components of the ediscovery system may also include a compute on-demand 4580 system. The compute on-demand 4580 system may include API gateways 4585, container app jobs 4590 and Azure functions 4595.

The container app jobs 4590 may be run in the background and typically may comprise long running jobs. The container app jobs 4590 may be containerized and run on any desired computer network. As a non-limiting example, the container app jobs 4590 may be run on an Azure Serverless Kubernetes environment (Container App Environment).

The Azure functions 4595 may be serverless compute and perform any desired actions. Serverless computing may be a method of providing backend services on an as-used basis. As non-limiting examples, the Azure functions 4595 may prepare messages for indexing, getting index status and running searches. The compute on-demand 4580 may also include API gateways 4585. The API gateways 4585 may provide access to indexing and search components from other parts of the applications.

Referring to FIG. 7, an example high-level data flow is illustrated according to an embodiment of the invention. The method starts with receiving an input file 4600 that includes data collected from one or more communication platforms that were stored on one or more computers and/or devices that were taken from one or more entities during the discovery process. After importing the data, a database may be created where each message contained within input file 4600, time of message, who sent the message and who received the message is a different row in the database. This permits conversations or topics that include a plurality of different messages possibly from different communication platforms store on different devices from a plurality of different entities to be determined. In some embodiments, the user may be able to annotate individual messages with tags. The annotations and tags may also be saved for later use. The searching process may be repeated on the index file share 4565 as many times as desired.

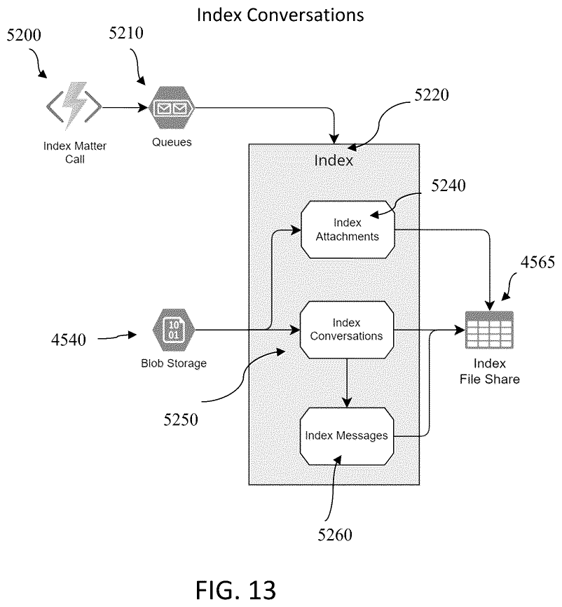

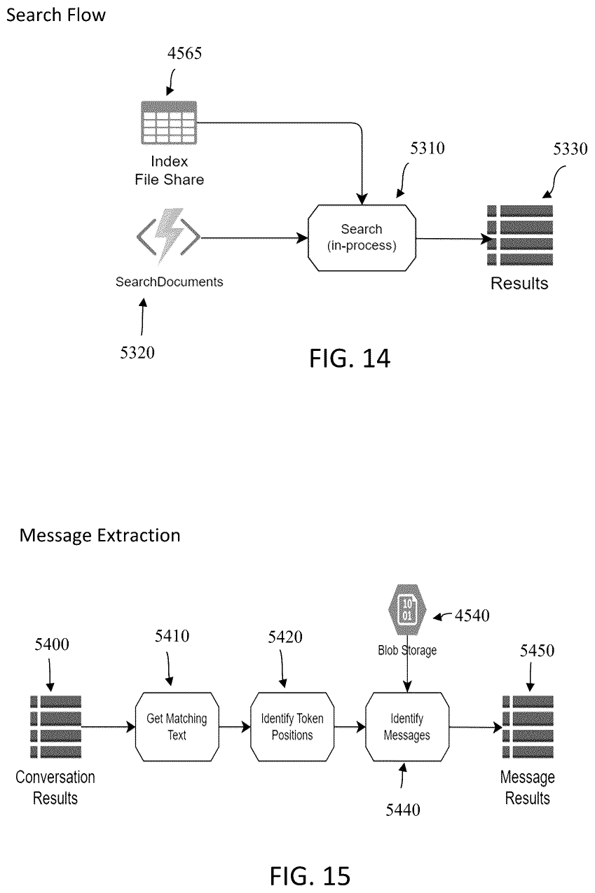

A load data function 4610 may load the data and store the data in a matter database 4520. The load data function 4610 may be used to enrich some of the data such as calculating a hash for later deduplicating items or calculating the likely name for participants. The load data function 4610 may also extract attachment content for indexing. The input file 4600 may be stored in any desired format. As a non-limiting example, the input file 4600 may be loaded into SQL databases within the matter databases 4520. A prepare conversations function 4630 may then interact with the data stored in the matter database 4520 as more fully explained in FIG. 8. The prepared conversations may be stored in a blob storage 4540. An index conversation function 4650 may index the data in the blob storage 4540 and store the results in a file share 4565 as more fully explained in FIG. 13. Queues 4550 may be either transferred to the index conversations function 4650 or to a batch search function 4690. Queues may be used during indexing to limit concurrent writes to the Lucene index in order to avoid data corruption. The search function 4670, explained in greater detail with reference to FIG. 14, may take data from the file share 4565 or the batch search 4690 to obtain the desired search results.

Referring to FIG. 8, a possible method for preparing conversations flow is illustrated according to an embodiment of the invention. A prepare conversation flow may be done for each conversation (group of messages). In preferred embodiments there are no limits on a time range when different “conversations” in the conversation flow may occur. However, a mechanism may be provided to the user to specify a time range to search in or a time range for the entire matter in order to better target conversation data. A “conversation” is a grouping of messages either by a thread provided from external data or an algorithm that uses participant identifier information such as email and/or phone number. In the case of the latter any messages that have the same participants in the same messaging application type will be grouped together into a “conversation”. Messages, even from different communication platforms, devices and entities may be grouped together in chronological order to produce conversations. In a preferred embodiment, each conversation may be used to produce two blobs, i.e., a conversation blob and an offsets blob, that may be stored in the blob storage 4540.

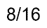

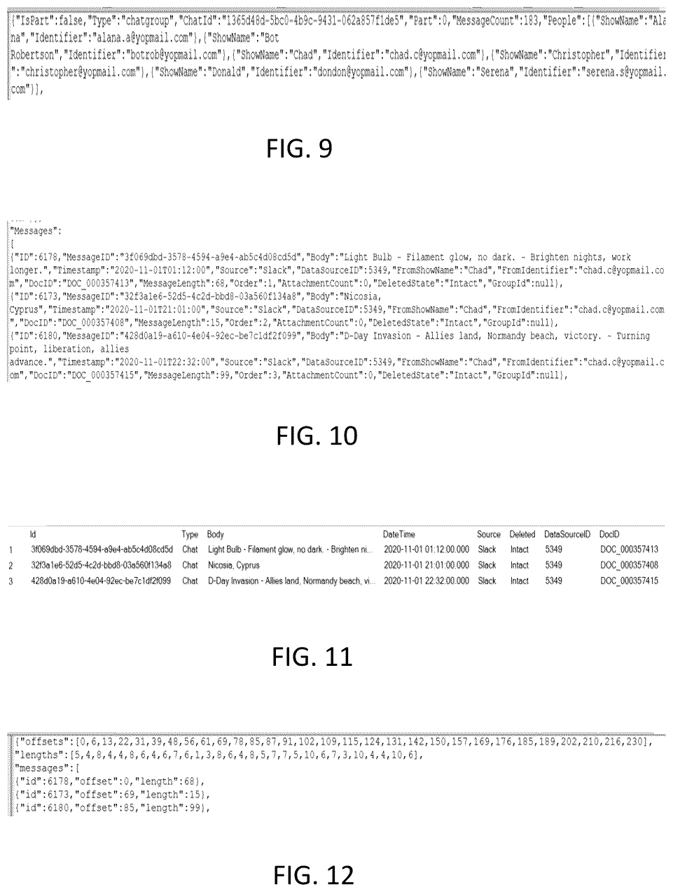

The conversation blob may contain messages that constitute the conversation in chronological order and contain the full conversation level text. An example of the raw data in a conversation blog is illustrated in FIG. 9.

A messages section of the conversation blob contains the text of each message along with metadata for each message and its order number in the conversation. An example of the raw data in the message section of the conversation blob is illustrated in FIG. 10. This allows the full text of the conversation to be indexed in support of searching for boolean operators such as an AND and NOT across that entire conversation text. It also allows for the support of proximity searching such as Light w/5 Filament across the entire conversation text.

The integer ID field allows the messages to be quickly linked to the respective offset information. The MessageID field provides a link to the message information that was stored in the SQL databases. An example of raw data with the integer ID field is illustrated in FIG. 11.

The offsets blob may contain message boundaries in terms of offsets and tokenized word boundaries. When a search is run, the offsets blob may be used to retrieve a list of words matching a search condition. These words, based on word boundaries, may be used to identify the messages that hit on the search criteria. The offset blob may comprise any number of different parts. In a preferred embodiment, the offset blob includes three parts, i.e., an offset of each word in the conversation as relating to the start of the conversation; a length of each word in the conversation; and the messages in the conversation as well as their respective offsets and lengths. An example of raw data in an offsets blog is illustrated in FIG. 12.

Referring to FIG. 13, a possible method of indexing conversations using the conversation blob and the offsets blob stored in the blob storage 4540 is illustrated. The method may start with the full text of the conversation being indexed along with the data at the message level.

The information may be prepared during indexing. Specifically, for each communication platform, e.g., group or channel, all of the text from all of the messages is received, ordered and combined. The offsets and lengths may be maintained within the conversation for each of the messages. The conversation text may then be tokenized to find the offset for each token. The details for each conversation may be saved in an index file share 4565.

A queue may be used to trigger an indexing job that produces the index information. A conversation may be indexed to allow for a full transcript search. Messages may be indexed to provide the ability to determine message level search results. Emails and attachments may also be indexed to allow for email and attachment level search results. Text and additional metadata may be extracted from any desired attachments. In the case of images, OCR may be used on the images to determine any text and thumbnails may be created for image formats that are not natively supported for viewing. Thumbnails for video files may be provided for a quick preview viewing. For video and audio files, including voicemail or voice recordings, text may be transcribed for the purpose of displaying and indexing for a search. The text for the transcript of the conversation along with the metadata may be stored. Metadata about participants For participants, their Role (From/To), Name (which may be calculated from likely name), whether they are the phone owner, and their Identifier which could be a phone number, email address, etc. may be stored. Participant names are displayed in the conversation view to indicate who was involved in the conversation and who was the sender of each message. Participant identifiers are used to build conversations and they are also tied to People so that it may be determined when a Person has different emails and phone numbers, Dates of the conversations and tags are also preferably indexed so that searches can be based, as non-limiting examples, on the participants, dates of conversations and tags.

Referring to FIG. 14, a possible method of a search flow 5310 is illustrated according to an embodiment of the invention. The method allows a user to enter a search query comprising one or more search terms, offsets and/or boolean logic for the search. There are two ways that users can use time as a parameter for filtering search data. The first is that users can use a date range to filter within a time frame. When specifying the time frame users may pick a minimum or maximum date for the messages to fall into. Once the time range has limited the messages that are considered, the search criteria must also be met within that time range. In the example of an AND search where Term1 AND Term2 are used as criteria, both terms must fall within messages that meet the timeframe criteria. Since messages are ordered chronologically, offsets may be used to ensure that the search criteria is met within messages that fall within the specified timeframe.

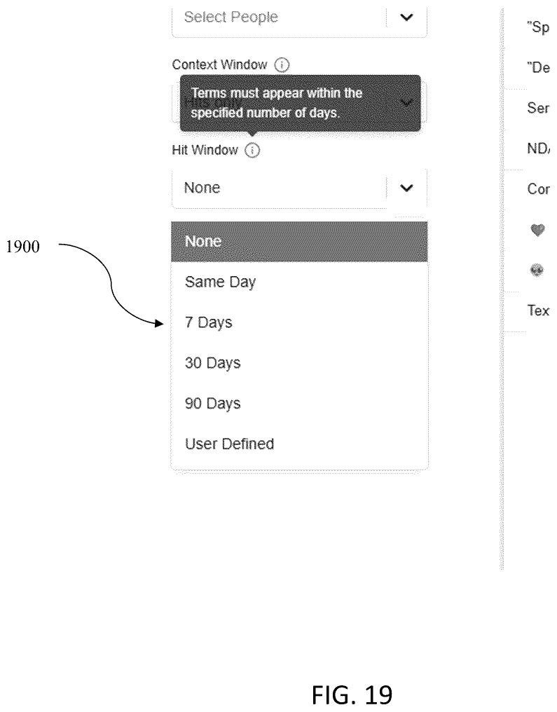

Referring to FIG. 19, the second way that time can be used is as a parameter for maximum time interval between term hits. With the example of Term1 AND Term2, if a user specifies a maximum 7 day interval 1900, then messages must hit on both Term1 and Term2, and Term1 must occur within 7 days of Term2. When using time parameters, the criteria is applied to AND and proximity operators. Beyond time frames, users can also filter their searches on the data source, such as which device the data was pulled from. In addition, users may also filter the search based on the participants or the type of data, such as email, voicemail, messages etc. Tags also offer another way for users to filter data. Tags may be user work product or applied by the system such as the search term tags. There may also be an option to filter based on AI Classifications such as Potential Trade Secret, Financial Misconduct, etc. The search flow 5310 identifies every conversation hit by at least one of the search terms in the search query.

The hits within the conversation are identified and provided as tokens. A conversation is a concatenated text of messages in a group ordered by time. When these conversations are built, the offset and length for each message may be stored. The metadata for each message like sender, timestamp etc. may also be determined. For a query containing AND or proximity queries, text hit can span across multiple messages. Depending upon the offset of the search hit, the actual message may be translated and identified. In the case of a time bound searches, the messages which fall outside of the range from the hits may be eliminated. The search may then reevaluated to ensure, even after removing out of date range, that all elements of the search conditions are successfully tagged. Messages that fall within the offsets of the tokens and the boolean logic for the tokens may be identified as part of the search result 5330. This method allows the search flow 5310 to search the index file share 4565 to produce the search results 5330 that may be displayed to the user.

In a preferred embodiment, a user may search an entire conversation transcript and receive message level hits. It is possible to search for multiple concepts/terms within the same conversation using AND, and NOT operators. The logical operators will need to intersect with the data parameters and time frame searches. In an example of an AND search with two terms and a time frame, both terms will need to show up in messages that are present in a given time frame. A concept may be created using proximity or phrase queries that can span across multiple messages collected from one or a plurality of computers and/or devices and from one or a plurality of entities.

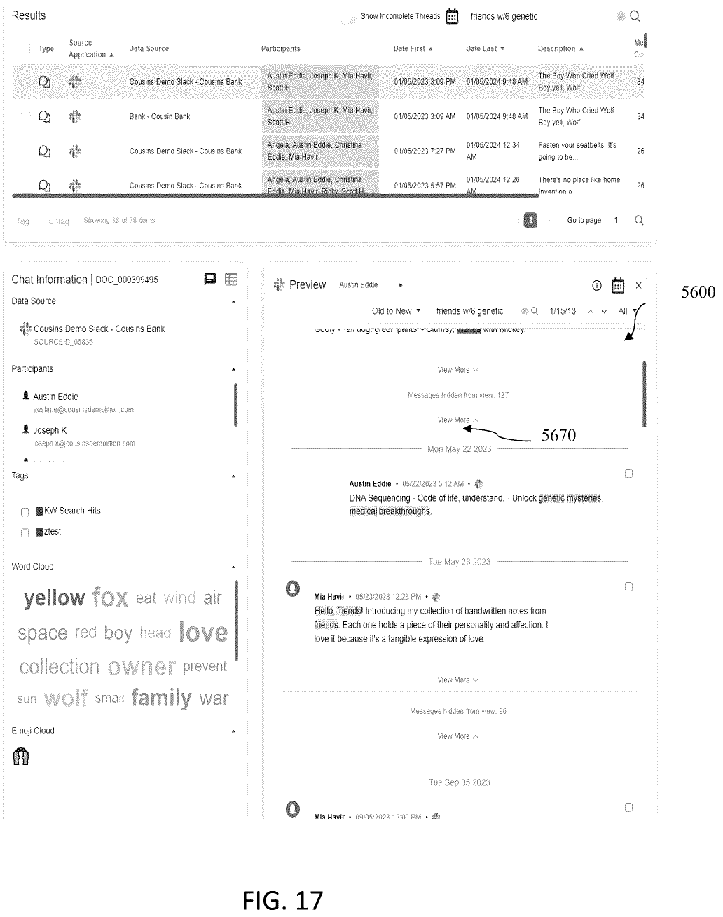

As the user performs their searches the conversations may be narrowed down to just those matching the search criteria. Furthermore, the view of the message level transcript may be narrowed down to just messages that match the criteria to bring the user's focus to the content they are looking for as shown in FIG. 17.

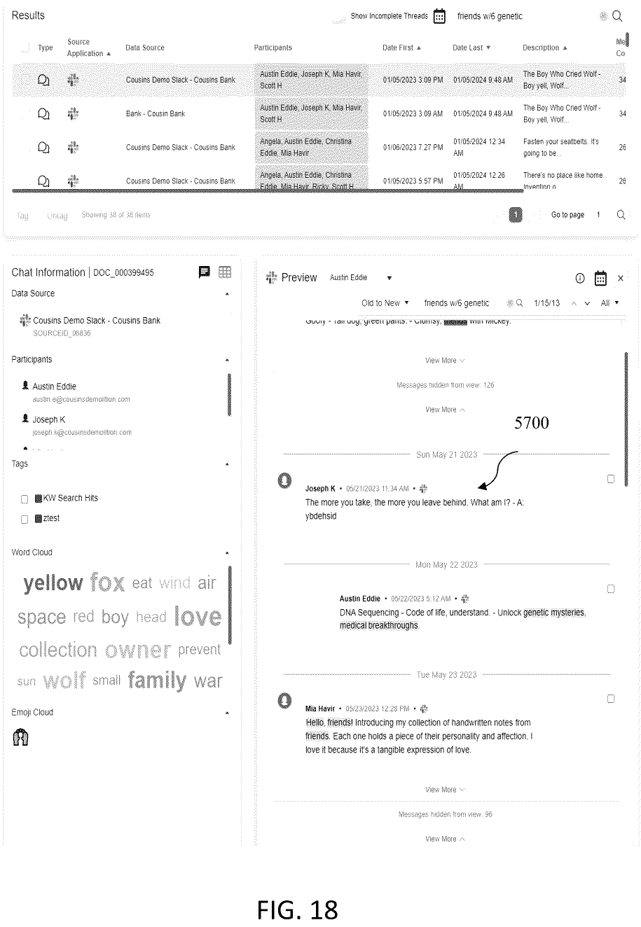

As all of the messages in the index file share are stored chronologically, the user may view additional messages either backward or forward in time from the hits or tokens to provide additional context to the user as shown in FIG. 18, even if the additional messages did not fall within the offsets or Boolean logic in the search query.

Referring to FIG. 15, a method for message extraction is provided. As users search for concepts using proximity and Boolean logic, tokens can be located across multiple messages and hence searching at the full conversation level may be very advantageous. At the same time, identifying messages that contribute to those concepts and the entities that participated in those messages is also critical to narrowing down the number of messages that the user is looking for.

When a search is run, a list of matching conversations that contributed to the search may be identified. (Step 5410) Each conversation may be analyzed independently and prepared for display as shown in FIG. 17. The parts of the message that match any of the search terms in the search query are preferably highlighted. The token positions of the highlighted words may be identified. Using the offsets determined during the indexing flow 5420 and saved in the blob storage 4540, a message results 5450 may be determined from the identified messages 5440 to be displayed as illustrated in FIG. 17.

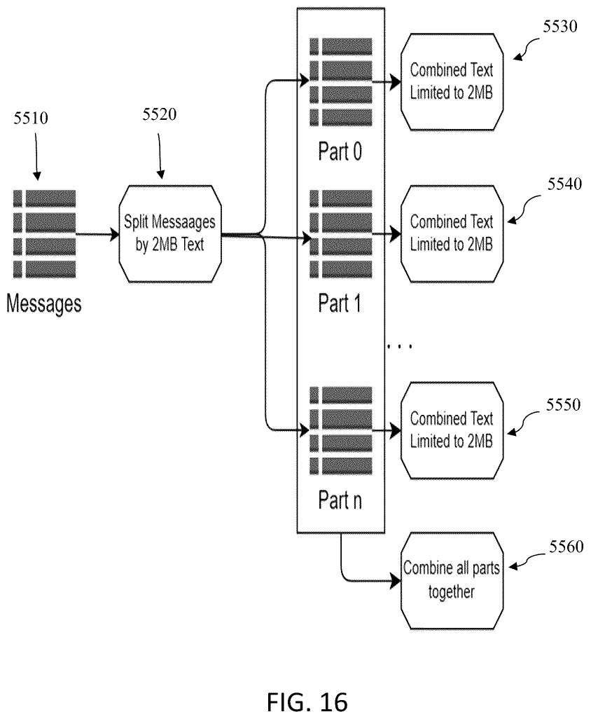

Referring to FIG. 16, a method for processing large conversations while maintaining a high level of performance is illustrated. When the text of all the messages from all of the entities' devices storing text from all the different platforms they use is combined, the conversation's full text may be very large. It may be highly desirable to have consistently quick searches regardless of the size of the index file share 4565 and search documents 5320. However, identifying messages based on search hits is more efficient when the size of the indexed file share 4565 is limited, such as to 2 Megabytes.

In one possible embodiment of the invention, the messages may be split in such a way that the text of the conversation is limited to 2 Megabytes (or to some other relatively small data size). This may result in a plurality of different parts. However, splitting the messages into different parts poses two new problems. When a conversation is split, a search combining two concepts may fail as one concept may be in one part while the other concept may be in another part resulting in relevant messages being missed.

This issue may be addressed by combining all the parts to a single text part and using this single text part only to identify if multiple parts are required to satisfy the whole search query. As a non-limiting example, for large conversations having 5 parts, there may be a 6th document that has all the text from all the parts combined.

Though the original search query may be performed on a combined text document, search hits are preferably retrieved from parts that are limited to 2 Megabytes for performance reasons. As the original search query already had a hit, individual concepts (or phrases) are searched on parts only and the combined text may be ignored, i.e., unsearched.

Even this method may miss some hits as search queries with phrases and proximity offsets may be broken in two parts while splitting the messages into multiple parts. To avoid this issue, each part may have an overlap of some number of characters in every part such that proximity queries still tag within a part. While the overlap may be any desired number, as a non-limiting example the beginning (except for the first part) and the end (except for the last part) may have an overlap of 50K characters with the previous or subsequent parts. With this method large conversions may be searched with fast performance.

One of the challenges in locating relevant messages is using typical proximity search approaches to short messages. One possible embodiment is to combine relevant short messages that are determined, possibly using key words, to belong to a plurality of different groups and/or channels into a continuous text and treat all of the short individual messages as a single document based on their chronology, who the sender is and who the receivers are. Combining messages has many advantages such as users can view the single document, instead of all of the different groups and/or channels of the short messages and be able to see a coherent flow of information.

However, when all of the short messages are combined into the single document from the plurality of different groups and/or channels, the connection to the original messages and the original messages' context may be lost. It may be desirable to be able to review the single document but identify additional messages that may match the given search context.

Referring to FIG. 17, the system preferably displays only the content that matches at least one of the search terms in the search query that caused the hit and hide or collapse the nearby messages that may otherwise obscure the search results. Thus, the messages that are initially displayed are only the messages that led to a hit on the search term, all other messages are preferably initially collapsed so that the messages that caused the search query hit may be easily seen on the display.

Referring to FIG. 18, the system may support a view more 5670 functionality that alerts the user to additional content or messages that are out of view. The additional content or messages may be expanded by the user (displayed for view) by selecting the view more functionality option. This expands the search beyond only the search hits to the search query to display more context and messages about the conversation. In preferred embodiments, users may interact with the original messages and/or the newly displayed messages that provided the additional context. As an example, one or more messages 5700 may be displayed in a window 5600 that were previously collapsed. The search index supports this capability by providing tokens for the hits identified in the full transcript of each conversation. The token position is used to offset within the conversation and identify the messages included in the search hit. The search index also tracks the chronological order each message appeared in the conversation to facilitate narrowing and expanding the message level view by bringing in messages that are +/−n distance from the current message order. Any messages that have a consecutive order will be grouped together for display.

When the conversation, i.e., a combined transcript of a group, channel, or text conversation, is indexed or prepared, a reference of each message that contributes to the document may be maintained in terms of each short messages' offsets and lengths. The offsets correspond to database records at the individual message level so the information may be recorded at that level of granularity. This may be used to determine how far apart messages are from each other. When users search for the content using techniques like proximity, Boolean logic, negation etc. this embodiment may get the actual hits and identify which messages belong to these hits.

A method for determining relevant messages during an e-discovery process will now be provided. A plurality of messages from each of a plurality of communication applications from each of a plurality of electronic devices from each of a plurality of entities may be imported. The electronic devices may be computers and cell phones. The plurality of messages may be stored in chronological order in a file share. A search query may be received from a user, wherein the search query comprises one or more search terms, Boolean logic and a proximity indicator. A hit plurality of messages in the plurality of messages in the file share may be determined that satisfy the search query. A context plurality of messages in the plurality of messages that are immediately before or immediately after the hit plurality of messages may also be determined. The hit plurality of messages may be displayed to the user that satisfy the search query in a functional display window. The system may detect that the user selected a view more command associated with a hit message in the hit plurality of messages, wherein the view more command is for a message before the hit message. A context message from the context plurality of messages may be displayed immediately before the hit message in the functional display window, thereby providing the user additional context information related to the hit message.

The inventions and methods described herein can be viewed as a whole, or as a number of separate inventions, that can be used independently or mixed and matched as desired. All inventions, steps, processed, devices, and methods described herein can be mixed and matched as desired. All previously described features, functions, or inventions described herein or by reference may be mixed and matched as desired.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A method for determining relevant messages during an e-discovery process, comprising the steps of:
importing a plurality of messages from each of a plurality of communication applications from each of a plurality of electronic devices from each of a plurality of entities;
storing the plurality of messages in chronological order in a file share;
receiving a search query from a user, wherein the search query comprises one or more search terms, boolean logic and a proximity indicator;
determining a hit plurality of messages in the plurality of messages in the file share that satisfy the search query;
determining a context plurality of messages in the plurality of messages that are immediately before or immediately after the hit plurality of messages;
displaying the hit plurality of messages to the user that satisfy the search query in a functional display window;
detecting that the user selected a view more command associated with a hit message in the hit plurality of messages in the functional display window; and
displaying a context message from the context plurality of messages immediately before or immediately after the hit message in the functional display window, determined by the view more command.

2. The method of claim 1, wherein the view more command is for a message before the hit message; and
displaying the context message from the context plurality of messages immediately before the hit message in the functional display window.

3. The method of claim 1, wherein the view more command is for a message after the hit message; and
displaying the context message from the context plurality of messages immediately after the hit message in the functional display window.

4. The method of claim 1, wherein the view more command in the functional display window is detected immediately after the user hovers a mouse pointer over the view more command and left clicks a mouse.

5. The method of claim 1, wherein the view more command in the functional display window is detected immediately after the user presses, with either a finger or a stylus, the view more command in the functional display window.

6. The method of claim 1, wherein the electronic devices comprise computers and/or cell phones.

7. A method for searching for one or more messages out of a corpus of messages, comprising the steps of:
receiving a first plurality of messages from a first application on a first device;
receiving a second plurality of messages from a second application on a second device;
normalizing and combining the first plurality of messages and the second plurality of messages to create the corpus of messages;
scraping the corpus of messages for emoji used in the corpus of messages;
scraping the corpus of messages for keywords used in the corpus of messages;
displaying a functional emoji cloud built from the used emoji;
displaying a functional keyword cloud built from the used keywords;
detecting a selected one or more emojis from the functional emoji cloud;
detecting a selected one or more keywords from the functional keyword cloud; and
displaying the one or more messages out of the corpus of messages that includes the selected one or more emojis from the functional emoji cloud and the selected one or more keywords from the functional keyword cloud.

8. The method of claim 7, wherein the first device is a different device than the second device.

9. The method of claim 8, wherein the first application on the first device and the second application on the second device are different applications that store data differently.

10. The method of claim 7, wherein data from the first application on the first device comprises text messages, while data from the second application on the second device comprises audio messages.

11. The method of claim 7, wherein data from the first application on the first device comprises text messages, while data from the second application on the second device comprises video.

12. The method of claim 7, wherein data from the first application on the first device comprises text messages, while the data from the second application on the second device comprises financial transactions.

13. The method of claim 7, wherein the selected one or more emoji are detected immediately after a user hovers a mouse pointer over the selected one or more emoji in the functional emoji cloud and left clicks a mouse.

14. The method of claim 7, wherein the selected one or more emoji are detected immediately after a user presses, with either a finger or a stylus, the selected one or more emoji in the functional emoji cloud.

15. The method of claim 7, wherein the selected one or more keywords are detected immediately after a user hovers a mouse pointer over the selected one or more keywords in the functional keyword cloud and left clicks a mouse.

16. The method of claim 7, wherein the selected one or more keywords are detected immediately after a user presses, with either a finger or a stylus, the selected one or more keywords in the functional keyword cloud.

17. A method for displaying a single conversation thread based on messages from a plurality of platforms, comprising the steps of:
receiving a first plurality of messages from a first application on a first device;
receiving a second plurality of messages from a second application on the first device;
normalizing and combining the first plurality of messages and the second plurality of messages;
placing the first plurality of messages from the first application and the second plurality of messages from the second application in chronological order to create a single conversation thread; and
displaying the single conversation thread on a user interface.

18. The method of claim 17, wherein the single conversation thread comprises data from distinct applications on different devices.

19. The method of claim 17, wherein the first device was owned and operated by a first person distinct from a second person that owned and operated the second device.

20. The method of claim 17, wherein the single conversation thread comprises data from text messages and financial transactions.
